(19) United States
(12) Patent Application Publication
(10) Pub. No.: US 2020/0341412 A1
(43) Pub. Date: Oct. 29, 2020

(54) 3D IMAGE FORMING METHOD AND 3D IMAGE FORMING APPARATUS

(71) Applicant: Konica Minolta, Inc., Tokyo (JP)

(72) Inventors: Kouji SUGAMA, Tokyo (JP); Michiyo FUJITA, Tokyo (JP); Seijiro TAKAHASHI, Tokyo (JP); Haruo HORIGUCHI, Tokyo (JP)

(21) Appl. No.: 16/845,843

(22) Filed: Apr. 10, 2020

(30) Foreign Application Priority Data
Apr. 26, 2019 (JP) 2019-085645

(51) Int. Cl. G03G 15/20

(52) U.S. Cl. CPC G03G 15/2007

(57) ABSTRACT

A 3D image forming method for forming a color 3D image on a recording medium having a thermal expansion property includes irradiating a medium surface on which the toner image is formed with light having a maximum emission wavelength in a wavelength range of 280 nm or more and 780 nm or less and being allowed to be absorbed by a compound contained in toner.

### CROSS-REFERENCE TO RELATED APPLICATION

The entire disclosure of Japanese Patent Application No. 2019-085645, filed on Apr. 26, 2019, is incorporated herein by reference in its entirety.

### BACKGROUND

### 1. Technical Field

The present invention relates to a three-dimensional (3D) image forming method and a 3D image forming apparatus.

### 2. Description of Related Arts

Conventionally, there has been a known thermally expandable sheet (or a thermal foaming sheet) in which a thermal expansion layer (or foam layer) containing foaming microcapsules that expand by heating is formed on one side of a base sheet. By irradiating light including infrared light after printing a high light-absorbing image pattern on the thermally expandable sheet, the thermal expansion layer in a region corresponding to the image pattern is heated and expanded, and a 3D image corresponding to the image pattern can be formed on one side of the base sheet. As a method of forming a color 3D image by such a 3D image forming technology, for example, JP 01-28659 A describes a scheme in which after forming an image using a color image forming material and an image forming material better in light absorption property than it on a thermally expandable sheet having a coating layer containing thermally expandable microcapsules on a surface thereof, only an image part is selectively heated by irradiating light, and the microcapsules in the coating layer in a region corresponding to the image is expanded, thereby forming a color 3D image.

In addition, JP 2006-220740 A describes a scheme of forming a 3D image by irradiating, with infrared light, an image including transparent toner containing an infrared absorbent and color toner on a thermal foaming recording medium.

In addition, JP 2001-150812 A discloses a foam molding system in which a foam layer is selectively foamed in a foaming sheet provided with the foam layer on a base material layer, thereby shaping a semi-3D image.

### SUMMARY

However, in the scheme described in JP 01-28659 A, black toner and color toner are mixed or overlapped and used as a high light-absorbing material, and thus there is a problem with color reproducibility. In addition, in the scheme described in JP 2006-220740 A, when the toner is melted, the transparent toner and the color toner are mixed, and thus there is a problem that the color density decreases. In addition, in the system described in JP 2001-150812 A, light is irradiated from a back surface of the foam layer, and thus there is a problem that an edge of the 3D image is blurred and a sharp 3D image may not be obtained.

In other words, the conventional method has a problem that a color 3D image having sufficient fixing strength, excellent color reproducibility, and a sharp edge may not be obtained.

Therefore, an object of the invention is to provide a 3D image forming method and a 3D image forming apparatus capable of forming a color 3D image having sufficient fixing strength, excellent color reproducibility, and a sharp edge.

The present inventors have conducted intensive research in view of the above problems. As a result, the inventors have found that the above-mentioned problems can be solved by the following 3D image forming method, and have completed the invention.

A 3D image forming method reflecting an aspect of the invention to achieve at least one of the objects is a 3D image forming method for forming a color 3D image on a recording medium having a thermal expansion property, the method including at least
developing an electrostatic latent image using toner to form a toner image,
transferring the toner image to the recording medium, and
irradiating a medium surface on which the toner image is formed with light having a maximum emission wavelength in a wavelength range of 280 nm or more and 780 nm or less and being allowed to be absorbed by a compound contained in the toner.

### BRIEF DESCRIPTION OF THE DRAWINGS

Advantages and features provided by one or more embodiments of the invention may be sufficiently understood with reference to the following detailed description and accompanying drawings. Note that the drawings are illustrated only for examples, and are not intended to define the scope of the invention.

FIG. 1 is a schematic cross-sectional view schematically illustrating a state in which a 3D image of the present embodiment is formed. In FIG. 1, reference numeral 11 denotes a recording medium (thermally expandable sheet) having a thermal expansion property, reference numeral 11′ denotes a sheet portion to which a toner image is attached, reference numeral 12 denotes a base material layer, reference numeral 13 denotes a foam layer, reference numeral 13′ denotes an expanded foam layer, reference numeral 14 denotes a coat layer, reference numeral 14′ denotes a coat layer on the expanded foam layer, reference numeral 15 denotes a toner image, and reference numeral 16 denotes light having a maximum emission wavelength within a wavelength range of 280 nm or more and 780 nm or less, respectively.

FIG. 2 is a schematic configuration diagram illustrating an image forming apparatus according to an embodiment of the invention. In FIG. 2, reference numeral 20 denotes an image reading unit, reference numeral 21 denotes a paper feeder, reference numeral 22 denotes a scanner, reference numeral 23 denotes a CCD sensor, reference numeral 24 denotes an image processing unit, reference numeral 30 denotes an image forming part, reference numeral 31 denotes an image forming unit, reference numeral 32 denotes a photosensitive drum, reference numeral 33 denotes a charging device, reference numeral 34 denotes an exposure device, reference numeral 35 denotes a developing unit, reference numeral 36 denotes a cleaning device, reference numeral 40 denotes an intermediate transfer unit, reference numeral 41 denotes a primary transfer unit, reference numeral 42 denotes a secondary transfer unit, reference numeral 43 denotes an intermediate transfer belt, reference numeral 44 denotes a primary transfer roller, reference numeral 45 denotes a backup roller, reference numeral 46 denotes a first support roller, reference numeral 47 denotes a cleaning device, reference numeral 48 denotes a secondary transfer belt, reference numeral 49 denotes a secondary transfer roller, reference numerals 50a and 50b denote second support rollers, reference numeral 55 denotes a light irradiation unit (light source), reference numeral 60 denotes a fixing unit, reference numeral 61 denotes a fixing belt, reference numeral 62 denotes a heating roller, reference numeral 63 denotes a first pressing roller, reference numeral 64 denotes a second pressing roller, reference numeral 80 denotes a recording medium conveyance unit, reference numeral 81 denotes a paper feed tray unit, reference numeral 82 denotes a resist roller pair, reference numeral 100 denotes a 3D image forming apparatus, reference numeral D denotes originals, and reference numeral S denotes a recording medium (thermally expandable sheet) having a thermal expansion property, respectively.

FIG. 3 is a block diagram illustrating a hardware configuration of the image forming apparatus. In FIG. 3, reference numeral 18 denotes a controller, reference numeral 19 denotes a storage unit, reference numeral 30 denotes the image forming part, reference numeral 35 denotes the developing unit, reference numeral 40 denotes the intermediate transfer unit, reference numeral 55 denotes the light irradiation unit (light source), reference numeral 70 denotes an operation panel, reference numeral 75 denotes a communication unit, reference numeral 80 denotes the recording medium conveyance unit, and reference numeral 100 denotes the 3D image forming apparatus, respectively.

FIG. 4 is a flowchart illustrating a 3D image forming method.

FIG. 5A is a schematic cross-sectional view schematically illustrating one mode of a recording medium having a thermal expansion property. FIG. 5B is a schematic cross-sectional view schematically illustrating another mode of the recording medium having the thermal expansion property. In FIG. 5A and FIG. 5B, reference numerals 90a and 90b denote recording media having thermal expansion properties (thermally expandable sheets), reference numeral 91 denotes a base material layer, reference numeral 92 denotes a foam layer, reference numeral 93 denotes microcapsules, reference numeral 94 denotes a coating portion, and reference numeral 95 denotes a coat layer, respectively.

FIG. 6 is a diagram illustrating formation positions of a toner image A, a toner image B, and a toner image C on an A4-sized thermally expandable sheet of Example 9.

### DETAILED DESCRIPTION OF EMBODIMENTS

Hereinafter, an embodiment of the invention will be described. However, the scope of the invention is not limited to the disclosed embodiment.

In this specification, unless otherwise specified, the operation and measurement of physical properties, etc. are performed under the conditions of room temperature (20° C. or more and 25° C. or less)/relative humidity of 40% RH or more and 50% RH or less.

A 3D image forming method according to an embodiment of the invention is a 3D image forming method for forming a color 3D image on a recording medium having a thermal expansion property, the method including at least
developing an electrostatic latent image using toner to form a toner image,
transferring the toner image to the recording medium, and
irradiating a medium surface on which the toner image is formed with light having a maximum emission wavelength in a wavelength range of 280 nm or more and 780 nm or less in a wavelength range in which the light is allowed to be absorbed by a compound contained in the toner.

A 3D image forming apparatus according to an embodiment of the invention is a 3D image forming apparatus for forming a color 3D image on a recording medium having a thermal expansion property, the apparatus including at least
a developing unit that develops an electrostatic latent image using toner to form a toner image,
a transfer unit that transfers the toner image to the recording medium, and
a light irradiation unit that irradiates a medium surface on which the toner image is formed with light having a maximum emission wavelength in a wavelength range of 280 nm or more and 780 nm or less in a wavelength range in which the light is allowed to be absorbed by a compound contained in the toner.

By having the above configuration, the 3D image forming method and the 3D image forming apparatus of the present embodiment can form a color 3D image in which a fixing strength is high, color reproducibility is excellent, and an edge is sharp.

A detailed reason for obtaining the above-described effects by the 3D image forming method and the 3D image forming apparatus of the present embodiment is unclear. However, the following action mechanism can be considered. Note that the action mechanism below is based on a presumption, and the invention is not limited by the action mechanism below.

### Structure of 3D Image

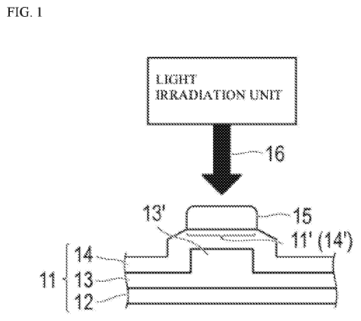

The “recording medium having the thermal expansion property” in the present embodiment refers to a recording medium containing a material whose heated portion expands. FIG. 1 is a schematic cross-sectional view schematically illustrating a state in which a 3D image of the present embodiment is formed. As illustrated in FIG. 1, a thermally expandable sheet 11, which is an embodiment of a recording medium having a thermal expansion property, has a foam layer 13 containing a thermally expandable material that foams and expands according to the amount of heat absorbed, for example, a large number of microcapsules (not illustrated) that expand by heating on one surface of a base material layer 12 (also referred to as a base paper layer). Further, a coat layer 14 may be provided on the foam layer 13. The foam layer 13 is a layer that expands to a size according to a heating temperature and a heating time. For example, the foam layer 13 is a layer in which a plurality of thermally expandable materials (thermally expandable microcapsules; hereinafter, also simply referred to as microcapsules) is dispersed in a binder. The microcapsules are obtained by encapsulating a low-boiling-point vaporizable substance such as propane, butane, etc. with a thermoplastic resin. When the microcapsules are heated, the substance in the microcapsules starts to evaporate and expand when a predetermined temperature (thermal expansion start temperature) is reached. That is, when the microcapsules are heated to a predetermined temperature or higher, shells of the capsules made of the thermoplastic resin are softened, the low-boiling-point vaporizable substance contained therein is vaporized, and the capsules expand due to the pressure. The foam layer 13 is, for example, white, and the thermally expandable sheet 11 is, for example, white.

After transferring a toner image 15 to a surface of the foam layer 13, a medium surface on which a toner image 15 is formed is irradiated with light in a wavelength region that can be absorbed by the compound contained in the toner image 15, which is light 16 having a maximum emission wavelength within a wavelength range of 280 nm or more and 780 nm or less. After absorbing the light 16 in the irradiated wavelength range to transition from a ground state to an excited state, the compound irradiated with the light 16 deactivates without radiation and returns to the ground state again. In this instance, thermal energy is released. By the released thermal energy, peripheral resin included in the toner image 15 is softened and melted, and the toner image 15 is fixed on the thermally expandable sheet 11 corresponding to a recording medium. At the same time, the thermal energy generated from the toner image 15 is transmitted to a sheet portion 11′ to which the toner image adheres to expand microcapsules in a foam layer 13′ of the sheet portion 11′. When the thermally expandable sheet 11 further has the coat layer 14, the expanding foam layer 13′ and a coat layer 14′ thereon bulge, and a 3D image is formed.

In the present embodiment, as the toner image 15 forming the 3D image, it is possible to use a color image formed by a normal electrophotographic method. It is preferable not to use a transparent toner containing an infrared absorbent or a black toner in a superimposed manner for the toner image 15. In this case, the color development is good and the color reproducibility is excellent. In addition, in the case of further having the coat layer 14 on a surface side of the foam layer 13, when the light 16 is irradiated from a surface side of the coat layer 14, the foam layer 13′ at a portion to which the toner image adheres and the coat layer 14′ thereover selectively bulge to form an image in which an edge is sharp.

Note that the above action mechanism is based on a presumption, and the invention is not limited by the action mechanism.

Hereinafter, the 3D image forming method and the 3D image forming apparatus according to the present embodiment will be described.

### 3D Image Forming Apparatus

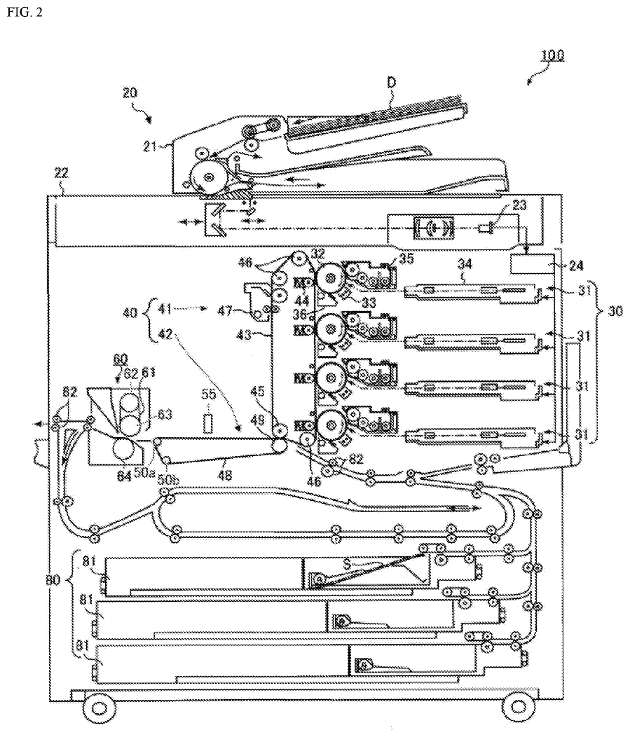

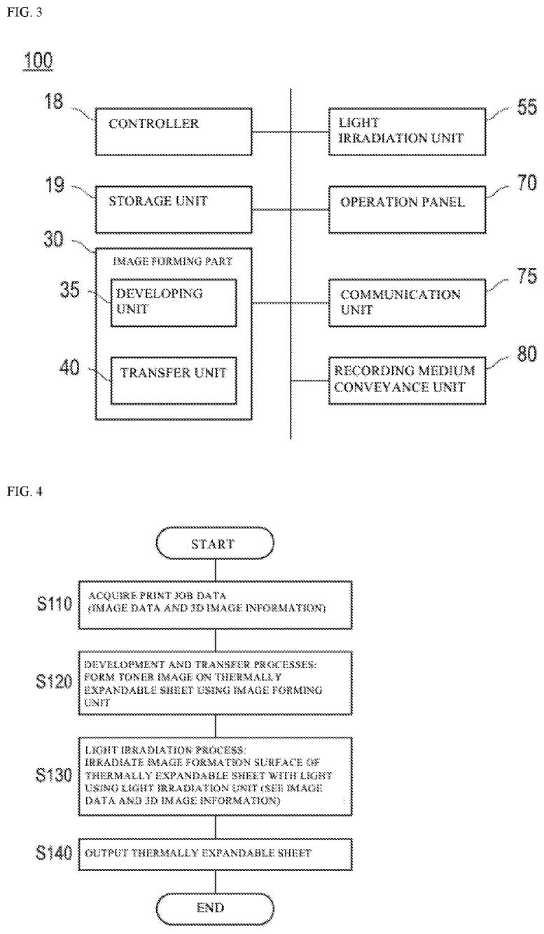

FIGS. 2 and 3 are views illustrating a basic configuration of a 3D image forming apparatus 100 of the present embodiment. As illustrated in FIG. 2 and FIG. 3, the image forming apparatus 100 is a 3D image forming apparatus that forms a color 3D image on a recording medium (thermally expandable sheet) S having a thermal expansion property, and includes a controller 18, a storage unit 19, an image forming part 30 having a developing unit 35 that develops an electrostatic latent image using toner to form a toner image, a light irradiation unit 55 that irradiates a medium surface on which the toner image is formed with light in a wavelength region that can be absorbed by a compound A contained in the toner, which is light having a maximum emission wavelength within a wavelength range of 280 nm or more and 780 nm or less, an operation panel 70, a communication unit 75, and a recording medium conveyance unit 80. Note that, in the 3D image forming apparatus 100 of the present embodiment, a fixing unit 60 may be provided so that a normal two-dimensional (2D) image can be formed using a normal recording medium. The image forming part 30 includes a developing unit 35 that develops the toner image, and an intermediate transfer unit 40 that transfers the developed toner image to a recording medium S.

The controller 18 includes a CPU (Central Processing Unit), a RAM (Random Access Memory), a ROM (Read Only Memory), etc. Data processed by the controller 18 is temporarily stored in the RAM. Various programs and various data are stored by the ROM.

The storage unit 19 stores various types of setting information related to the image forming apparatus 100.

For example, a correspondence relationship between a position of each pixel of an image in print image data described later and an irradiation exposure position of the light irradiation unit 55 is stored. In addition, a correspondence between a three-dimensional (3D) height (bulging height) of the recording medium described later and irradiation energy is stored.

The operation panel 70 includes a touch panel, numeric keys, a start button, a stop button, etc., and functions as a display unit and an operation unit. The operation panel 70 is used to input various settings such as printing conditions, display a status of the apparatus, and input various instructions. In addition, through the operation panel 70, a user can set a region (hereinafter referred to as a “3D region”) in which the toner image corresponds to a 3D image in an image region of image data or a height of the 3D image (bulging height) when the toner image corresponds to the 3D image. The 3D region may be set in units of objects (characters such as letters, lines, or photographic images) of an image, or may be set by designating region coordinates. In addition, the height of the 3D region (bulging height) may be uniformly set to the same height on one recording medium S, or may be set at each of a plurality of heights for each partial region in one recording medium. Hereinafter, information about the 3D region and information about the height are collectively referred to as “3D image information”.

The communication unit 75 is an interface for various local connections such as a network interface for wired communication according to a standard such as Ethernet (registered trademark), etc. or an interface for wireless communication according to a standard such as Bluetooth (registered trademark) IEEE802.11, etc. and performs communication with a user terminal such as a PC (personal computer) connected to a network. The user may be able to set 3D image information for print image data using a printer driver on a PC. In this case, the image forming apparatus 100 receives a print job including the 3D image information and the print image data via the communication unit 75.

### Input Mechanism for 3D Image Data (3D Image Information)

In the 3D image forming apparatus 100 of the present embodiment, an image reading unit 20 may be provided so that a normal 2D image can be formed using a normal recording medium. The image reading unit 20 reads an image from an original D and obtains image data for forming an electrostatic latent image. The image reading unit 20 includes a paper feeder 21, a scanner 22, a CCD sensor 23, and an image processing unit 24. In the present embodiment, when the image can be read from the original D of the 3D image, the image reading unit 20 can be used without change.

For example, the original D of the 3D image placed on an original platen of the paper feeder (automatic original feeder) 21 is scanned and exposed by an optical system of a scanning exposure device of a scanner (image reading device) 22, and read into the CCD sensor (image sensor CCD) 23. An analog signal photoelectrically converted by the image sensor CCD 23 is subjected to analog processing, A/D conversion, shading correction, image compression processing, etc. in the image processing unit 24, and then input to the exposure device 34 of the image forming part 30.

In addition, when the image is difficult to read since the original D is a 3D image, the 3D image information may be set using the operation panel 70 or an external PC (printer driver) as described above.

### Configuration of Image Forming Part Having Developing Unit

In the 3D image forming apparatus 100 of the present embodiment, the image forming part 30 includes, for example, four image forming units 31 corresponding to respective colors of yellow, magenta, cyan, and black. The image forming unit 31 includes a photosensitive drum 32, a charging device 33, an exposure device 34, a developing unit 35, and a cleaning device 36.

The photosensitive drum 32 is, for example, a negatively charged organic photoreceptor having photoconductivity. The charging device 33 charges the photosensitive drum 32. The charging device 33 is, for example, a corona charger. The charging device 33 may correspond to a contact charging device that charges a contact charging member such as a charging roller, a charging brush, a charging blade, etc. by bringing the contact charging member into contact with the photosensitive drum 32. The exposure device 34 irradiates the charged photosensitive drum 32 with light based on the print image data to form an electrostatic latent image. The exposure device 34 is, for example, a semiconductor laser. The developing unit 35 develops the electrostatic latent image using toner to form a toner image. Specifically, the developing unit 35 supplies toner to the photosensitive drum 32 on which the electrostatic latent image is formed to form a toner image corresponding to the electrostatic latent image. For example, the developing unit 35 is a known developing unit (developing device) in an image forming apparatus of an electrophotographic method. The cleaning device 36 removes residual toner on the photosensitive drum 32. Here, the “toner image” refers to a state in which the toner collects on the photosensitive drum 32 in an image form. The “toner image” refers to a state in which the toner aggregates on the recording medium S in an image form.

The toner is not particularly limited as long as the toner contains a compound that absorbs light having a maximum emission wavelength in a wavelength range of 280 nm or more and 780 nm or less (also simply referred to as the compound A), and it is possible to appropriately select, from known toners, and use toner satisfying the above requirements. The toner may be used as a one-component developer, or may be mixed with carrier particles and used as a two-component developer. The one-component developer includes toner particles. In addition, the two-component developer includes toner particles and carrier particles. The toner particles include toner base particles and an external additive such as silica, etc. adhering to a surface thereof. The toner base particles include, for example, a binder resin, a colorant, and wax. A specific configuration, conditional requirement, etc. of the toner will be described later.

### Structure of Transfer Unit

The 3D image forming apparatus 100 according to the present embodiment includes a transfer unit 40 that transfers a toner image to the recording medium S. Hereinafter, a configuration using the intermediate transfer unit illustrated in FIG. 2 as the transfer unit 40 will be described as an example. However, the invention is not limited thereto. For example, the 3D image forming apparatus 100 may be configured to have no intermediate transfer unit. As illustrated in FIG. 2, the intermediate transfer unit 40 includes a primary transfer unit 41 and a secondary transfer unit 42. The primary transfer unit 41 includes an intermediate transfer belt 43, a primary transfer roller 44, a backup roller 45, a plurality of first support rollers 46, and a cleaning device 47. The intermediate transfer belt 43 is an endless belt. The intermediate transfer belt 43 is stretched by the backup roller 45 and the first support roller 46. The intermediate transfer belt 43 travels on an endless track at a constant speed in one direction by rotationally driving at least one of the backup roller 45 and the first support roller 46.

The secondary transfer unit 42 includes a secondary transfer belt 48, a secondary transfer roller 49, and a plurality of second support rollers 50 (for example, two second support rollers 50a and 50b). The secondary transfer belt 48 is an endless belt. The secondary transfer belt 48 is stretched by the secondary transfer roller 49 and the second support roller 50.

### Structure of Light Irradiation Unit

The 3D image forming apparatus 100 according to the present embodiment includes the light irradiation unit 55 that irradiates a medium surface on which the toner image is formed with light having a maximum emission wavelength within a wavelength range of 280 nm or more and 780 nm or less, which can be absorbed by a compound contained in the toner. For example, the light irradiation unit 55 is located above the secondary transfer belt 48 between the secondary transfer roller 49 and the second support roller 50a where the recording medium S is conveyed and at a position where a medium surface on which the toner image on the recording medium S is formed can be irradiated. The light source that can be used for the light irradiation unit 55 is not particularly limited as long as the light source can irradiate the above specific light. However, a light emitting diode (LED) or a laser light source is preferable. The LED and the laser light source are excellent in that the wavelength range of the irradiating light is narrow, and it is possible to irradiate only the light in the wavelength range absorbed by the toner image, so that the efficiency is high and the power consumption can be further reduced. When the wavelength range of the irradiating light is wide, light in a wavelength which may not be absorbed by the toner is included, so that the efficiency is low and the power consumption increases. However, when a light source can irradiate the above specific light, the light source can be applied. Since it is sufficient that the light hits the medium surface on which the toner image is formed, the light irradiation unit may have any configuration as long as light irradiation is performed after forming the toner image.

The wavelength range of the light irradiated by the light irradiation unit 55 is a wavelength range in which the compound A contained in the toner can absorb the light, and the maximum emission wavelength of the light is 280 nm or more and 780 nm or less. The “maximum emission wavelength” of the light source that can be used for the light irradiation unit 55 refers to an emission wavelength at which the emission intensity is the maximum among maximum values of emission peaks in an emission spectrum of the light source. The light irradiation may be performed on an image (a medium surface on which a toner image is formed) heated for fixing. In addition, heating for fixing may be performed after light irradiation. However, it is most preferable in terms of energy efficiency that heat generation of compound A of the toner image by light irradiation causes thermal expansion of the microcapsules in the recording medium at the same time as fixing of the toner image. To fix the toner image and form a 3D image, it is necessary to efficiently raise the temperature of the toner, thermally melt the toner, transfer heat to the recording medium S, and expand the microcapsules in the foam layer. The amount of thermal energy released depends on the energy of the irradiated light, the absorbance of the compound A, the photo stability of the compound A, etc. When the compound A, which absorbs light in the wavelength range of 280 nm or more and 780 nm or less, contained in the toner is irradiated with light having the maximum emission wavelength in the wavelength range, it is possible to obtain a 3D image in which the fixing strength is high, bulging is large, and an edge is sharp. Here, in the case of heating for fixing before light irradiation, it is preferable to perform heating in a range in which the microcapsules in the foam layer are not expanded. A temperature at which the microcapsules expand in the foam layer can be adjusted by design of the microcapsules. In addition, in the case of heating for fixing after light irradiation, it is preferable to perform heating in a range in which the microcapsules in the foam layer are not expanded, and it is preferable to perform pressurization in a range in which an expanded portion is not crushed. Pressurization in the range in which the expanded portion is not crushed can be adjusted by the pressure of the fixing unit.

A maximum emission wavelength of light irradiated by the light irradiation unit 55 is preferably 280 nm or more and 680 nm or less. A reason therefor is that sufficient energy is obtained for fixing the toner image and forming the 3D image, the fixing strength is high, and a 3D image in which bulging is large and an edge is sharp is obtained. Further, the maximum emission wavelength of light is more preferably 280 nm or more and 480 nm or less. A reason therefor is that there is no need to change the light source depending on the type of the colorant, and space can be saved by simple device formation.

The light source used in the light irradiation unit 55 may be disposed so that an entire region in a short direction (also referred to as a width direction or a main scanning direction) of the medium perpendicular to a conveyance direction (longitudinal direction of the medium) of the recording medium S can be irradiated at a time, or the light source may perform partial irradiation. Alternatively, a plurality of light sources may be arranged in the width direction so that an irradiation position can be changed. For example, it is possible to use an irradiation optical system in which a plurality of LEDs for irradiating ultraviolet light and a plurality of lenses are arranged along the width direction so as to irradiate the entire region in the width direction. For example, the LEDs can perform irradiation at a resolution of 1 dpi or more on the recording medium S. Preferably, irradiation at a resolution of 50 dpi is preferable, and 100 dpi or more is more preferable. In addition, it is preferable that the irradiation energy for each dot can be controlled in a plurality of stages. For example, it is preferable that control can be performed in a plurality of stages in a range from several J/cm² to several tens J/cm². The increase or decrease of the irradiation energy may be controlled by controlling the light emission amount of the LED or by changing a conveyance speed of the recording medium S to be conveyed immediately below the light irradiation unit 55. In this way, the recording medium S can be continuously irradiated while being conveyed. In this case, the light irradiation is preferably performed while the recording medium S is being conveyed. Further, the light source may be disposed so as to irradiate the entire region of the recording medium S at a time. In this way, after stopping the recording medium S immediately below the light source, the entire region of the recording medium S can be irradiated at a time. In this case, the light irradiation is preferably performed by stopping the recording medium S at an irradiation position for each sheet. Further, a semiconductor laser may be used as the light source. A plurality of semiconductor lasers may be disposed so that the entire region of the recording medium can be irradiated at a time, the semiconductor laser may be movable so that the entire region of the recording medium can be successively irradiated with light, or it is possible to use a method in which laser light irradiated from the semiconductor laser is scanned by rotating a polygon mirror.

In the present embodiment, the compound A that absorbs the light in the wavelength range to be irradiated refers to a compound, the absorbance of the maximum emission wavelength of which in the wavelength range of the irradiation light is 0.01 or more when the compound is dissolved at a concentration of 0.01% by mass in a solvent and the absorbance is measured using a spectrophotometer. As the solvent, for example, it is possible to use DMF, THF, chloroform, etc.

The irradiation light amount of the light in the light irradiation unit 55 may be controlled in accordance with the type and content of the compound A contained in the toner within a range where the effects of the present embodiment can be obtained. For example, the irradiation light amount is preferably controlled within a range of 0.01 J/cm² or more and 100 J/cm² or less, and more preferably controlled within a range of 0.1 J/cm² or more and 50 J/cm² or less.

The recording medium conveyance unit 80 has three paper feed tray units 81 and a plurality of resist roller pairs (conveyance rollers) 82. The recording medium S identified based on the basis weight, the size, the expansion ratio, etc. is stored in the paper feed tray units 81 for each type set in advance. The resist roller pairs 82 are disposed so as to form an intended conveyance path.

In the 3D image forming apparatus 100 of the present embodiment, the fixing unit 60 may be provided so that a normal 2D image can be formed using a normal recording medium. The fixing unit 60 includes an endless fixing belt 61 and a heating roller 62 having a heating device (not illustrated) for heating the fixing belt 61 from the inside, and has two or more rollers 62 and 63 that shaft-support the fixing belt 61, and a pressing roller 64 disposed to be urged relatively to one of the rollers (roller 63) via the fixing belt 61. For example, the fixing unit 60 is a known fixing unit (fixing device) in an image forming apparatus of an electrophotographic method.

In such a 3D image forming method using the image forming apparatus 100, the transfer unit 40 forms the toner image on the recording medium S sent by the recording medium conveyance unit 80 based on the image data acquired by the image reading unit 20 and the 3D image information designated by the user. The recording medium S on which the toner image is formed by the transfer unit 40 is sent to the light irradiation unit 55.

Meanwhile, the recording medium S supporting the unfixed toner image is conveyed onto the secondary transfer belt 48 between the secondary transfer roller 49 and the second support roller 50a. Thereafter, the light irradiation unit 55 provided above the secondary transfer belt 48 irradiates the set light irradiation position with light within the specific wavelength range of the set irradiation amount on the basis of position information of the toner image based on the print image data and 3D image information of the toner image designated by the user. When the compound A absorbs the light within the specific wavelength range, the compound A transitions from a ground state to an excited state, then deactivates without radiation, and returns to the ground state again. In this instance, thermal energy is released, peripheral resin included in the toner image is softened and melted by the released thermal energy, and the toner image is fixed on the recording medium S. At the same time, thermal energy generated from the toner image is transmitted to a sheet portion to which the toner image adheres. As a result, the microcapsules in the foam layer of the sheet portion expand, and a coat layer portion immediately above the foam layer can be bulged via the expanding foam layer to form a 3D image. In this way, the unfixed toner image supported on the recording medium S is rapidly fixed on the recording medium S by irradiating specific light, and a 3D image is formed. The recording medium S on which the toner image is fixed and the 3D image is formed by the light irradiation unit 55 is sent to the fixing unit 60. Here, the conveyed recording medium S on which the 3D image is formed passes without coming into contact with the fixing belt 61 moving upward following the heating roller 62 moving upward, and is guided toward the outside of the image forming apparatus 100 by a guide roller (not illustrated). Note that as described above, a mode illustrated in FIG. 2 has a configuration in which the fixing unit 60 is present on the downstream side of the light irradiation unit 55. However, the light irradiation unit 55 may be present on the downstream side of the fixing unit 60.

Note that in the case of forming a normal 2D image using a normal recording medium, fixing may be performed by light irradiation. However, to cope with high-speed printing, a fixing method using a fixing belt is preferably used. In the case of using the fixing method using such a fixing belt, the recording medium S that supports the unfixed toner image is sent to the fixing unit 60 without being irradiated with light by the light irradiation unit 55, and is guided to a nip portion while being guided by a guide plate (not illustrated). Then, by the fixing belt 61 coming into close contact with the recording medium S, the unfixed toner image is rapidly fixed to the recording medium S. In addition, the recording medium S receives an airflow from an airflow separator (not illustrated) at a downstream end of a fixing nip portion. For this reason, separation of the recording medium S from the fixing belt 61 is promoted. The recording medium S separated from the fixing belt 61 is guided toward the outside of the image forming apparatus 100 by guide rollers (not illustrated).

In more detail, the 3D image forming apparatus of the present embodiment is a 3D image forming apparatus including a light irradiation unit that rapidly performs fixing on the recording medium S and forming a 3D image by irradiating an unfixed toner image formed by the electrophotographic method on the recording medium S having the thermal expansion property with light in the wavelength range which can be absorbed by the compound contained in the toner. By having such a configuration, the above-described effects can be effectively exhibited.

### 3D Image Forming Method

Hereinafter, the 3D image forming method according to the present embodiment will be described with reference to FIG. 4. FIG. 4 is a flowchart illustrating a procedure of the 3D image forming method.

### Step S110

The image forming apparatus 100 acquires print job data. The print job data includes print image data and 3D image information. The print image data is image data obtained by reading an image from the original D by the image reading unit 20, or image data received via the communication unit 75. The 3D image information is information input by the user via the operation panel 70.

### Step S120: Development Process and Transfer Process

The present embodiment includes a development process of forming a toner image by developing the electrostatic latent image with toner of step S120, and a transfer process of transferring the toner image to a recording medium.

Specifically, based on the print image data acquired in step S110, the image forming part 30 forms the toner image on the recording medium through the development process and the transfer process. A photoconductor drive motor (not illustrated) starts by a start of image recording, a photosensitive drum Y 32 (an uppermost photosensitive drum in the figure) rotates in a direction indicated by an arrow in the figure, and a potential is applied to the photosensitive drum Y 32 by a charging device Y 33. After the potential is applied to the photosensitive drum Y 32, exposure (image writing) by an electric signal corresponding to a first color signal, that is, image data Y is performed by an exposure device Y 34, and an electrostatic latent image corresponding to a yellow (Y) image is formed on the photosensitive drum Y 32. This electrostatic latent image is reversely developed by a developing unit Y 35, and a toner image including yellow (Y) toner is formed on the photosensitive drum Y 32 (development process). A toner image Y formed on the photosensitive drum Y 32 is transferred onto the intermediate transfer belt 43 corresponding to an intermediate transfer member by the primary transfer roller 44 corresponding to primary transfer means.

Subsequently, an electric potential is applied to a photosensitive drum M 32 (a second photosensitive drum from the top in the figure) by a charger M 33. After the potential is applied to the photosensitive drum M 32, exposure (image writing) by an electric signal corresponding to a first color signal, that is, image data M is performed by an exposure device M 34, and an electrostatic latent image corresponding to a magenta (M) image is formed on the photosensitive drum M 32. This latent image is reversely developed by a developing unit M 35, and a toner image including magenta (M) toner is formed on the photosensitive drum M 32 (development process). A toner image M formed on the photosensitive drum M 32 is superimposed on the toner image Y and transferred onto the intermediate transfer belt 43 corresponding to an intermediate transfer member by the primary transfer roller 44 corresponding to primary transfer means.

Through a similar process, a toner image including cyan (C) toner formed on a photosensitive drum C 32 (a third photosensitive drum from the top in the figure) and a toner image including black (K) toner formed on a photosensitive drum K 32 (a lowermost photosensitive drum in the figure) are successively superimposed and formed on the intermediate transfer belt 43, and a superimposed color toner image including Y, M, C, and K toners is formed on a peripheral surface of the intermediate transfer belt 43. The toner remaining on a peripheral surface of each photosensitive drum 32 after the transfer is cleaned by a photoreceptor cleaning device 36.

Meanwhile, the recording medium S having the thermal expansion property accommodated in the three paper feed tray units 81 of the recording medium conveyance unit 80 is fed by a feed roller and a paper feed roller provided in each of the three paper feed tray units 81. The recording medium S is conveyed on the conveyance path by the conveyance rollers, and is conveyed to the secondary transfer belt 48 corresponding to secondary transfer means to which a voltage having an opposite polarity to that of the toner (positive polarity in the present embodiment) is applied via the resist roller pair 82. Thereafter, in a transfer region of the secondary transfer belt 48, the superimposed color toner images formed on the intermediate transfer belt 43 are collectively transferred onto the recording medium S (transfer process). In this instance, as illustrated in FIG. 1, it is sufficient that the recording medium S having the thermal expansion property is accommodated in the paper feed tray unit 81 so that the color toner images are collectively transferred onto the coat layer 14 of the thermally expandable sheet 11 corresponding to the recording medium S.

After the toner image is transferred onto the recording medium S by the secondary transfer belt 48 corresponding to the secondary transfer means, the residual toner on the intermediate transfer belt 43 from which the recording medium S is separated by the curvature is removed by an intermediate transfer belt cleaning device 47. Further, patch image toner on the secondary transfer belt 48 is cleaned by a cleaning blade (not illustrated) of the secondary transfer unit 42.

### Step S130: Light Irradiation Process

The 3D image forming method of the present embodiment includes a light irradiation process of irradiating a medium surface on which the toner image is formed with light having a maximum emission wavelength within a wavelength range of 280 nm or more and 780 nm or less in a wavelength range which can be absorbed by the compound contained in the toner.

In a light irradiation process of step S130, the controller 18 controls the light irradiation unit 55. In the transfer process, the recording medium S to which the toner image is transferred is irradiated with the light in the specific wavelength range in the light irradiation unit 55, so that the toner image is fixed and the 3D image is formed. Thereafter, the recording medium S on which the 3D image is formed is conveyed through the apparatus and placed on a paper discharge tray outside the image forming apparatus 100.

Specifically, the recording medium S to which the toner image is transferred in the transfer process is conveyed onto the secondary transfer belt 48 between the secondary transfer roller 49 and the second support roller 50a. Thereafter, the light irradiation unit 55 irradiates the set light irradiation position of the recording medium S with light within the specific wavelength range of the set irradiation amount on the basis of position information of the toner image based on the print image data and 3D image information of the toner image designated by the user. When the compound A absorbs the light within the specific wavelength range, the compound A transitions from a ground state to an excited state, then deactivates without radiation, and returns to the ground state again. In this instance, thermal energy is released, peripheral resin included in the toner image is softened and melted by the released thermal energy, and the toner image is fixed on the recording medium S. At the same time, the thermal energy generated from the toner image is transmitted to the sheet portion to which the toner image adheres, the microcapsules in the foam layer of the sheet portion are expanded, and the foam layer (and the coat layer immediately thereon) is bulged, so that the 3D image can be formed. In this way, the unfixed toner image supported on the recording medium S is rapidly fixed on the recording medium S by irradiating specific light, and the 3D image is formed at the same time.

### Step S140

The recording medium S on which the 3D image is formed in step S130 is sent to the fixing unit 60 by the recording medium conveyance unit 80 in step S140. The recording medium S on which the 3D image is formed passes without coming into contact with the fixing belt 61 moving upward following the heating roller 62 moving upward, is guided toward the outside of the image forming apparatus 100, and is placed on the paper discharge tray outside the 3D image forming apparatus 100.

The 3D image forming apparatus 100 of the present embodiment may correspond to an apparatus used for the 3D image forming method of the present embodiment including the respective processes described above.

### Irradiation Light Wavelength Range

In the light irradiation process, it is preferable to irradiate light having a maximum emission wavelength in a wavelength range of 280 nm or more and 680 nm or less. A reason therefor is that sufficient energy is obtained for fixing the toner image and forming the 3D image, the fixing strength is high, and a 3D image in which bulging is large and an edge is sharp is obtained. In the light irradiation process, it is preferable to irradiate light having the maximum emission wavelength within the wavelength range of 280 nm or more and 480 nm or less. A reason therefor is that since toner to which a commonly used colorant is added absorbs light in a short wavelength range of 280 nm or more and 480 nm or less, there is no need to change the light source depending on the type of the colorant, and space can be saved by simple device formation.

### Setting of Light Irradiation Position and Setting of Light Irradiation Amount

In the light irradiation process, the light irradiation position in the specific wavelength range can be set on the basis of position information of the toner image based on print image data. In this way, light irradiation can be performed only on a necessary portion without irradiating the entire surface of the recording medium, so that energy can be saved. In addition, in the light irradiation process, the irradiation amount of the light in the specific wavelength range can be set based on the 3D image information of the toner image designated by the user. In this way, it is possible to control a bulging height for each position, and to represent various 3D images. Further, in the light irradiation process, it is possible to set the light irradiation position and the light irradiation amount on the basis of the position information of the toner image based on the print image data and the 3D image information of the toner image designated by the user. In this way, it is possible to save energy, control a bulging height for each position, and to represent various 3D images.

The position information of the toner image is print image information indicating a position of the toner image desired to be set to be three-dimensional, and is, for example, designated by the user from an input screen, etc. The 3D image information may be data obtained by converting the print image data into three dimensions. The 3D image information is print image information indicating a set height of a predetermined position of the toner image and is, for example, designated by the user from the input screen, etc. The height of the toner image can be controlled by appropriately selecting the light irradiation energy. For example, in the case of controlling in five stages, it is possible to arbitrarily control the height by setting a first stage to 5 J/cm², a second stage to 15 J/cm², a third stage to 25 J/cm², a fourth stage to 35 J/cm², a fifth stage to 50 J/cm², and the like in order from a lower side (see Example 6).

The light irradiation may be performed while conveying the recording medium S, or may be performed by stopping the recording medium S at the irradiation position for each sheet. Preferably, the light irradiation is performed while conveying the recording medium S since productivity can be increased.

The resolution depends on the type and size of the light source and the optical system (lens, etc.), and a higher resolution is preferable. The position information of the 3D image may be 1 dpi or more, preferably 50 dpi or more, and more preferably 100 dpi or more.

### Configuration of Recording Medium having Thermal Expansion Property

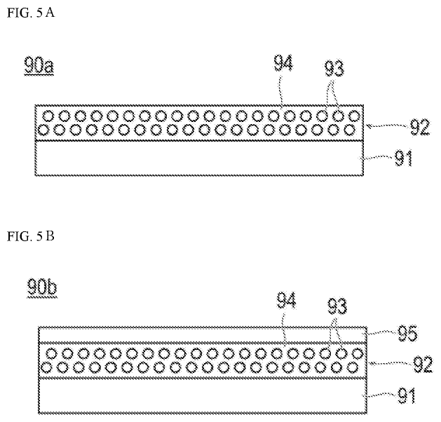

FIG. 5A is a schematic cross-sectional view schematically illustrating one mode of a recording medium having a thermal expansion property. FIG. 5B is a schematic cross-sectional view schematically illustrating another mode of the recording medium having the thermal expansion property.

As illustrated in FIG. 5A, a recording medium 90a having a thermal expansion property, which represents one aspect of the present embodiment, includes a base material layer 91 and a foam layer 92 stacked on the base material layer 91.

The base material layer 91 is provided for the purpose of supporting the foam layer 92. Specifically, it is possible to use paper such as high-quality paper, medium-grade paper, etc. or a commonly used resin sheet. A thickness of the base material layer 91 is preferably in a range of 10 μm or more and 1,000 μm or less, more preferably in a range of 30 μm or more and 50 μm or less, in view of the above-mentioned purpose of use.

The foam layer 92 is provided for the purpose of forming a 3D image by bulging, and includes a large number of microcapsules 93 that are spatially distributed and a coating portion 94 that covers these microcapsules 93. A thickness of the foam layer 92 before bulging is preferably in a range of 30 μm or more and 1,000 μm or less, more preferably 50 μm or more and 500 μm or less, from a viewpoint of controlling a height after bulging.

The microcapsules 93 are obtained by encapsulating a low-boiling-point vaporizable substance such as propane, butane, etc. with a thermoplastic resin such as vinylidene chloride-acrylonitrile copolymer, methacrylic acid ester-acrylic acid copolymer, vinylidene chloride-acrylic acid copolymer, vinylidene chloride-acrylic acid ester copolymer, etc., and a size thereof is about 10 μm or more and 30 μm or less as a particle size. When the microcapsules 93 are heated, the substance in the microcapsules 93 starts to evaporate when a predetermined temperature is reached, and the microcapsules 93 expand. The size in a state in which the microcapsules 93 are most expanded can be appropriately adjusted depending on the usage purpose, the type of substance used, the type of material of the coating portion, etc., and expansion can be arbitrarily performed in a range of 2 times or more and 10 times or less the particle size before expansion. The substance in the microcapsules 93 is in a vaporized state even after returning to room temperature after heating.

The coating portion 94 is fixed so that the microcapsules 93 are distributed at a substantially uniform density using, for example, a thermoplastic coating material such as a vinyl acetate polymer, an acrylic polymer, etc., and joins the base material layer 91 and the foam layer 92.

In addition, as illustrated in FIG. 5B, a recording medium 90b having a thermal expansion property, which represents another aspect of the present embodiment, includes a base material layer 91, a foam layer 92 stacked on the base material layer 91, and a coat layer 95 stacked on the foam layer 92. Providing the coat layer 95 is advantageous in that the foam layer can be protected before and after bulging. In a configuration of the recording medium 90b illustrated in FIG. 5B, the base material layer 91 and the foam layer 92 are as described for the recording medium 90a illustrated in FIG. 5A.

The coat layer 95 protects the foam layer and is provided as a surface layer on which a toner image is formed. The coat layer 95 is preferably a layer that can be thermally softened and deformed (bulged) following the bulge of the foam layer 92 due to expansion of the microcapsules 93, does not deteriorate even when heated similarly to the foam layer 92, is excellent in thermal conductivity, and can transfer heat to the foam layer 92 without consuming the thermal energy generated in the toner image as much as possible. Further, it is possible to use a layer that can be rapidly cooled and solidified in a deformed state to preserve a bulging state of the foam layer 92 after the light irradiation. Specifically, it is possible to use paper such as high-quality paper, a generally used resin sheet, etc. A thickness of the coat layer 95 before deformation is preferably in a range of 1 μm or more and 500 μm or less, more preferably 30 μm or more and 300 μm or less, from a viewpoint of following the bulging.

### Configuration of Toner

In the 3D image forming apparatus and the 3D image forming method of the present embodiment, electrostatic image developing toner containing the compound A that absorbs light (also simply referred to as toner) is used.

As the toner containing the compound A, it is preferable to use at least a color toner. Here, the color toner preferably includes at least one of yellow toner, magenta toner, and cyan toner. A high-quality full-color 3D image can be obtained using yellow toner, magenta toner, and cyan toner. In addition, the color toner may further include chromatic toner other than the yellow toner, the magenta toner, and the cyan toner (for example, orange toner, violet toner, etc.). By further including these other chromatic toners, the color reproduction range can be extended.

In addition, in the case of forming the color 3D image, toner other than the color toners may be further included. For example, it is possible to include black toner or transparent toner.

The toner according to the present embodiment is preferably a toner base particle or an aggregate of toner particles.

Here, the toner particles are obtained by adding an external additive to the toner base particle, and the toner base particle can be used as the toner particle without change.

### Compound that Absorbs Light

The compound (compound A) that absorbs light contained in the toner is a compound that absorbs light having a maximum emission wavelength within a wavelength range of 280 nm or more and 780 nm or less.

The “compound that absorbs the light having the maximum emission wavelength within the wavelength range of 280 nm or more and 780 nm or less” mentioned in the invention refers to a compound, the absorbance of the maximum emission wavelength of which in the wavelength range of 280 nm or more and 780 nm or less is 0.01 or more when the compound is dissolved at a concentration of 0.01% by mass in a solvent (DMF, THF, chloroform, etc.) and the absorbance is measured using a spectrophotometer.

As the compound A according to the invention, it is preferable to use a colorant such as yellow, magenta, cyan, black, etc., or an ultraviolet absorbent. In addition, for example, a resin, etc. that absorbs light can be used. Further, the compound A used in the invention may correspond to one type or two types or more.

### Colorant

The toner according to the invention preferably contains a colorant as the compound A. When the toner contains a colorant as the compound A, light in a short wavelength range of 280 nm or more and 480 nm or less is absorbed, and thus it is unnecessary to change the light source provided in the 3D image forming apparatus 100 depending on the type of the colorant. Therefore, it is unnecessary to provide a mechanism, etc. for replacing a plurality of light sources according to the type of the colorant, and the space can be saved with a simple device configuration. In addition, in production of the toner, the toner may not be produced in a work environment where ultraviolet rays are cut and may be produced using an ordinary composition component. Therefore, the toner can be simply and inexpensively produced in terms of the work environment, the number of processes, storage management of raw materials, etc. Generally known dyes and pigments can be used as the colorant.

Examples of the colorant for obtaining the black toner include carbon black, a magnetic substance, an iron/titanium composite oxide black, etc.

Examples of the carbon black include channel black, furnace black, acetylene black, thermal black, lamp black, etc. In addition, examples of the magnetic substance include ferrite, magnetite, etc.

Examples of the colorant for obtaining the yellow toner include dyes such as C.I. Solvent Yellow 19, 44, 77, 79, 81, 82, 93, 98, 103, 104, 112, 162, etc. and pigments such as C.I. Pigment Yellow 14, 17, 74, 93, 94, 138, 155, 180, 185, etc.

Examples of the colorant for obtaining the magenta toner include dyes such as C.I. Solvent Red 1, 49, 52, 58, 63, 111, 122, etc. and pigments such as C.I. Pigment Red 5, 48:1, 53:1, 57:1, 122, 139, 144, 149, 166, 177, 178, 222, 269, etc.

Examples of the colorant for obtaining the cyan toner include dyes such as C.I. Solvent Blue 25, 36, 60, 70, 93, 95, etc. and pigments such as C.I. Pigment Blue 1, 7, 15, 15:3, 60, 62, 66, 76, etc.

Examples of chromatic toner other than yellow toner, magenta toner, and cyan toner, for example, a colorant for obtaining the orange toner include pigments such as C.I. Pigment Orange 1, 11, etc., and examples of a colorant for obtaining the violet toner include pigments such as C.I. Pigment Violet 19, 23, 29, etc.

As the colorant for obtaining the toner of each color, one type or a combination of two or more types can be used for each color.

A content rate of the colorant is preferably in a range of 1% by mass or more and 30% by mass or less, more preferably 2% by mass or more and 20% by mass or less with respect to the total mass (100% by mass) of the toner. When the content rate is 1% by mass or more, sufficient coloring power can be obtained, and when the content is 30% by mass or less, the colorant is not released from the toner and does not adhere to a carrier, and the chargeability is stable. Therefore, a high-quality image can be obtained.

### Ultraviolet Absorbent

The toner of the present embodiment preferably contains an ultraviolet absorbent as the compound A.

The ultraviolet absorbent mentioned in this specification refers to an additive that has an absorption wavelength in a wavelength range of 180 nm or more and 400 nm or less, and is deactivated by non-radiation deactivation without accompanying a structural change such as isomerization, bond cleavage, etc. from an excited state under an environment of at least 0° C. or more. The ultraviolet absorbent may correspond to either an organic compound or an inorganic compound as long as the above conditions are satisfied. In addition to a general organic ultraviolet absorbent, a light stabilizer, an antioxidant, etc. can be used.

In addition, it is possible to use an ultraviolet-absorbing polymer with a functional group having an organic ultraviolet absorbent skeleton incorporated in a polymer chain.

The ultraviolet absorbent preferably has a maximum absorption wavelength in a wavelength range of 180 nm or more and 400 nm or less. Of the organic ultraviolet absorbent and the inorganic ultraviolet absorbent, the organic ultraviolet absorbent is more preferable.

Examples of the organic ultraviolet absorbent that can be used in the present embodiment include known ultraviolet absorbents such as a benzophenone ultraviolet absorbent, a benzotriazole ultraviolet absorbent, a triazine ultraviolet absorbent, a cyanoacrylate ultraviolet absorbent, a salicylate ultraviolet absorbent, a benzoate ultraviolet absorbent, a diphenylacrylate ultraviolet absorbent, a benzoic ultraviolet absorbent, a salicylic ultraviolet absorbent, a cinnamic ultraviolet absorbent, a dibenzoylmethane ultraviolet absorbent, a β,β-diphenylacrylate ultraviolet absorbent, a benzylidene camphor ultraviolet absorbent, a phenylbenzimidazole ultraviolet absorbent, an anthranil ultraviolet absorbent, an imidazoline ultraviolet absorbent, a benzalmalonate ultraviolet absorbent, a 4,4-diarylbutadiene ultraviolet absorbent, etc. Among the ultraviolet absorbents, the benzophenone ultraviolet absorbent, the benzotriazole ultraviolet absorbent, the triazine ultraviolet absorbent, the cyanoacrylate ultraviolet absorbent, and the dibenzoylmethane ultraviolet absorbent are preferable.

One type of these organic ultraviolet absorbents may be used alone, or two or more types thereof may be used in combination.

Examples of the benzophenone ultraviolet absorbent include octabenzone, 2,4-dihydroxybenzophenone, 2-hydroxy-4-methoxybenzophenone, 2,2′-dihydroxy-4-4′-dimethoxybenzophenone, 2-hydroxy-4-n -octyloxybenzophenone, etc.

Examples of the benzotriazole ultraviolet absorbent include 2-(2H-benzotriazol-2-yl)-4,6-bis(1-methyl-1-phenylethyl)phenol, 2-(5-chloro(2H)-benzotriazol-2-yl]-4-methyl-6-(t-butyl)phenol, 2-(2H-benzotriazol-2-yl)-4,6-di-t-pentylphenol, 2-(2H-benzotriazol-2-yl)-4-(1,1,3,3-tetramethylbutyl)phenol, methyl-3-[3-t-butyl-5-(2H-benzotriazol-2-yl)-4-hydroxyphenyl]propionate/polyethylene glycol(molecular weight about 300) reaction product, 2-(2H-benzotriazol-2-yl)-6-dodecyl-4-methylphenol, 2-(2-hydroxy-5-t-butylphenyl)-2H-benzotriazole, 2-ethylhexyl-3-[3-t-butyl-4-hydroxy-5-(5-chloro-2H-benzotriazol-2-yl)phenyl]propionate, 2-(2H-benzotriazol-2-yl)-4,6-bis(1-methyl-1-phenylethyl)phenol, 2-(2H-benzotriazol-2-yl)-6-(1-methyl-1-phenylethyl)-4-(1,1,3,3-tetramethylbutyl)phenol, etc.

Examples of the triazine ultraviolet absorbent include 2-(4,6-bis(2,4-dimethylphenyl)-1,3,5-triazine-2-yl)-5-hydroxyphenyl, 2-(4,6-diphenyl-1,3,5-triazine-2-yl)-5-[hexyl)oxy]phenol, 2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-(2′-ethyl)hexyl)oxy]-2-hydroxyphenyl]-4,6-bis(2,4-dimethylphenyl)-1,3,5-triazine, 2,4-bis(2-hydroxy-4-butyloxyphenyl)-6-(2,4-bis-butyloxyphenyl)-1,3,5-triazine, 2-(2-hydroxy-4-[1-octyloxycarbonyloxy]phenyl)-4,6-bis(4-phenyl)-1,3,5-triazine, etc.

Examples of the cyanoacrylate ultraviolet absorbent include ethyl 2-cyano-3,3-diphenylacrylate, 2′-ethylhexyl 2-cyano-3,3-diphenylacrylate, etc.

Examples of the dibenzoylmethane ultraviolet absorbent include 4-t-butyl-4′-methoxydibenzoylmethane (for example, “Parsol (registered trademark) 1789”, manufactured by DSM), etc.

Examples of the inorganic ultraviolet absorbent include titanium oxide, zinc oxide, cerium oxide, iron oxide, barium sulfate, etc. A particle size of the inorganic ultraviolet absorbent is preferably in a range of 1 nm or more and 1 μm or less in terms of volume-based median diameter. A particle size of ultraviolet absorbent particles can be measured using an electrophoretic light scattering photometer “ELS-800” (manufactured by Otsuka Electronics Co., Ltd.).

A content rate of the ultraviolet absorbent is preferably in a range of 0.1% by mass or more and 50% by mass or less with respect to the total mass (100% by mass) of the toner. When the content rate is 0.1% by mass or more, sufficient heat generation energy can be obtained. When the content rate is 50% by mass or less, it is possible to form a color 3D image having sufficient fixing strength and a sharp edge. The content rate of the ultraviolet absorbent is more preferably in a range of 0.5% by mass or more and 35% by mass or less. When the content rate is 0.5% by mass or more, the obtained thermal energy becomes larger, so that a fixing property is further improved. When the content rate is 35% by mass or less, a ratio of the resin is increased, so that a fixed image is toughened, the fixing property is further improved, and a color 3D image having a sharp edge can be formed.

In addition, it is preferable that the toner of the present embodiment contains a binder resin, a releasing agent, a charge control agent, etc. in addition to the compound A, and an external additive is added thereto. Hereinafter, these components will be described.

### Binder Resin

It is preferable that the binder resin contains an amorphous resin and a crystalline resin.

Since the toner according to the present embodiment contains the binder resin, the toner has an appropriate viscosity, and blurring is suppressed when the toner is applied to the thermally expandable sheet corresponding to a recording medium. Thus, fine line reproducibility and dot reproducibility are improved.

As the binder resin, a resin generally used as a binder resin included in toner can be used without limitation. Specifically, examples thereof include styrene resin, acrylic resin, styrene/acrylic resin, polyester resin, silicone resin, olefin resin, amide resin, epoxy resin, etc. These binder resins can be used alone or in combination of two or more types.

Among these binder resins, from a viewpoint of having a low viscosity when melted and having a high sharp melt property, the binder resin preferably contains at least one selected from the group consisting of styrene resin, acrylic resin, styrene/acrylic resin and polyester resin, and more preferably contains at least one selected from the group consisting of styrene/acrylic resin and polyester resin.

A glass transition temperature (Tg) of the binder resin is preferably in a range of 35° C. or more and 70° C. or less, more preferably in a range of 35° C. or more and 60° C. or less from viewpoints of a fixing property, a heat-resistant storage property, etc. The glass transition temperature can be measured by differential scanning calorimetry (DSC).

In addition, the toner according to the present embodiment preferably contains a crystalline polyester resin as the crystalline resin from a viewpoint of improving a low-temperature fixing property. In addition, from a viewpoint of further improving the low-temperature fixing property of the toner, as the crystalline polyester resin, it is preferable to contain a hybrid crystalline polyester resin in which a crystalline polyester polymerization segment and an amorphous polymerization segment are bonded. As the crystalline polyester resin and the hybrid crystalline polyester resin, for example, it is possible to use known compounds described in JP 2017-37245 A.

Note that the toner containing the binder resin may have a single-layer structure or a core-shell structure. A type of the binder resin used for core particles and a shell layer of the core-shell structure is not particularly limited.

### Releasing Agent

The toner according to the present embodiment may contain a releasing agent. The releasing agent used is not particularly limited, and various known waxes can be used.

Examples of the wax include polyolefins such as low molecular weight polypropylene, polyethylene, oxidized low molecular weight polypropylene, etc., paraffin, synthetic ester wax, etc.

In particular, synthetic ester wax is preferably used due to a low melting point and a low viscosity, and it is particularly preferable to use behenyl behenate, glycerin tribehenate, pentaerythritol tetrabehenate, etc.

A content rate of the releasing agent is preferably in a range of 1% by mass or more and 30% by mass or less, more preferably 3% by mass or more and 15% by mass or less with respect to the total mass of the toner.

### Charge Control Agent

The toner according to the present embodiment may contain a charge control agent. The charge control agent used is a substance capable of giving positive or negative charge by triboelectric charging, and is not particularly limited as long as the charge control agent is colorless. Further, it is possible to use various known positive charge control agents and negative charge control agents.

A content rate of the charge control agent is preferably in a range of 0.01% by mass or more and 30% by mass or less, more preferably 0.1% by mass or more and 10% by mass or less with respect to the total mass of the toner.

### External Additive

To improve the fluidity, chargeability, cleaning property, etc. of the toner, an external additive such as a fluidizing agent, a cleaning aid, etc. corresponding to a so-called post-treatment agent may be added to surfaces of the toner base particles.

Examples of the external additive include inorganic particles such as inorganic oxide particles such as silica particles, hydrophobic silica particles, alumina particles, titanium oxide particles, hydrophobic titanium oxide particles, etc. inorganic stearic acid compound particles such as aluminum stearate particles, zinc stearate particles, etc. and inorganic titanate compound particles such as strontium titanate particles, zinc titanate particles, etc.

These external additives can be used alone or in combination of two or more types.

These inorganic particles may be surface-modified with a silane coupling agent, a titanium coupling agent, a higher fatty acid, a silicone oil, etc. to improve heat resistant storage and environmental stability.

The addition amount of the external additive is preferably in a range of 0.05% by mass or more and 5% by mass or less, more preferably 0.1% by mass or more and 3% by mass or less with respect to the total mass of the toner.

### Average Particle Size of Toner Particles

The average particle size of the toner particles is preferably in a range of 4 μm to 10 μm, more preferably 4 μm to 7 μm in terms of volume-based median diameter (D50). When the volume based median diameter (D50) is within the above range, the transfer efficiency is increased, the image quality of halftone is improved, and the image quality of fine lines, dots, etc. is improved.

The volume-based median diameter (D50) of the toner particles is measured and calculated using a measuring device in which a computer system (manufactured by Beckman Coulter Co., Ltd.) equipped with data processing software “Software V3.51” is connected to “Coulter Counter 3” (manufactured by Beckman Coulter Co., Ltd.).

Specifically, 0.02 g of a measurement sample (toner) is added to 20 mL of a surfactant solution (a surfactant solution obtained by diluting a neutral detergent containing a surfactant component ten times with pure water for the purpose of dispersing toner particles, for example) and blended, and then ultrasonic dispersion is performed for 1 minute to prepare a toner particle dispersion. This toner particle dispersion is pipetted into a beaker containing “ISOTONII” (manufactured by Beckman Coulter Co., Ltd.) in a sample stand until the indicated concentration of the measuring device becomes 8%.

In the measuring device, the measurement particle count number is set to 25,000, the aperture diameter is set to 50 μm, a frequency value is calculated by dividing the measurement range from 1 μm to 30 μm into 256 parts, and the 50% particle size from the larger volume integral fraction is defined as the volume-based median diameter (D50).

### Production Method of Toner

A method for producing the toner according to the present embodiment is not particularly limited, and a known method can be employed. However, an emulsion polymerization aggregation method or an emulsion aggregation method can be suitably employed. Hereinafter, a description will be given of an example of a method for producing toner containing ultraviolet absorbent particles and a colorant as the compound A, in the toner particles.

The emulsion polymerization aggregation method is a method of mixing a dispersion of the binder resin particles produced by the emulsion polymerization method with a dispersion of the ultraviolet absorbent particles, a dispersion of the colorant particles, and further with a dispersion of the releasing agent such as the wax as necessary, performing aggregation until the toner particles have a desired particle size, and further controlling the shape by performing fusion between the binder resin particles, thereby producing toner particles.

In addition, the emulsion aggregation method is a method of dropping a binder resin solution into a poor solvent to form a binder resin particle dispersion, mixing the binder resin particle dispersion with the ultraviolet absorbent particle dispersion, the colorant particle dispersion, and further with the releasing agent such as the wax as necessary, performing aggregation until a desired toner particle diameter is obtained, and further controlling the shape by performing fusion between the binder resin particles, thereby producing toner particles.

Either manufacturing method can be applied to the toner used in the present embodiment.

When the emulsion polymerization aggregation method is used as the method for producing the toner, for example, a production method including the following processes (1) to (7) can be exemplified.

(1) Process of preparing a dispersion obtained by dispersing the colorant particles in an aqueous medium
(2) Process of preparing a dispersion obtained by dispersing the ultraviolet absorbent particles
(3) Process of preparing a dispersion of the binder resin particles by emulsion polymerization
(4) Process of mixing a dispersion of the colorant particles, a dispersion of the ultraviolet absorbent particles, and a dispersion of the binder resin particles, and aggregating, gathering, and fusing the colorant particles, the ultraviolet absorbent particles, and the binder resin particles, thereby forming the toner base particles.
(5) Process of filtering the toner base particles from a dispersion system (aqueous medium) of the toner base particles to remove a surfactant, etc.
(6) Process of drying the toner base particles
(7) Process of adding the external additive to the toner base particles

Note that the ultraviolet absorbent may not be added.

When the toner is produced by the emulsion polymerization aggregation method, the obtained binder resin particles may have a multilayer structure of two or more layers including binder resins having different compositions. For example, the binder resin particles having a two-layer structure can be obtained using a scheme of preparing a dispersion of resin particles by emulsion polymerization treatment (first-stage polymerization) according to a conventional method, adding a polymerization initiator and a polymerizable monomer to the obtained dispersion, and then performing a polymerization treatment (second-stage polymerization).

Further, toner particles having a core-shell structure can be obtained by the emulsion polymerization aggregation method. Specifically, in toner particles having the core-shell structure, first, core particles are produced by aggregating, gathering, and fusing the binder resin particles, the ultraviolet absorbent particles, and the colorant particles for the core particles. Subsequently, the binder resin particles for the shell layer are added to a dispersion of the core particles, the binder resin particles for the shell layer are aggregated and fused on core particle surfaces, and a shell layer covering the core particle surfaces are formed.

### Developer

In the toner according to the present embodiment, for example, it is possible to consider a case where a magnetic substance is contained and used as one-component magnetic toner, the case of being mixed with a so-called carrier and used as a two-component developer, a case where a non-magnetic toner is used alone, etc., and any of the cases can be suitably used.

As the magnetic substance, for example, magnetite, γ-hematite, various ferrites, etc. can be used.

As the carrier included in the two-component developer, it is possible to use magnetic particles including conventionally known materials such as a metal such as iron, steel, nickel, cobalt, ferrite, magnetite, etc. and an alloy of these metals and a metal such as aluminum, lead, etc.

As the carrier, it is preferable to use a coated carrier in which surfaces of the magnetic particles are coated with a coating material such as a resin, etc. or a so-called resin dispersion type carrier in which magnetic substance powder is dispersed in a binder resin. The resin for coating is not particularly limited, and examples thereof include an olefin resin, a styrene resin, a styrene/acrylic resin, an acrylic resin, a silicone resin, a polyester resin, and a fluororesin, etc. In addition, as a resin for forming the resin dispersion type carrier is not particularly limited, and a known resin can be used. Examples thereof include an acrylic resin, a styrene/acrylic resin, a polyester resin, a fluororesin, a phenol resin, etc.

The volume-based median diameter of the carrier is preferably in a range of 20 μm or more and 100 μm or less, and more preferably in a range of 25 μm or more and 80 μm or less. The volume-based median diameter of the carrier can be typically measured by a laser diffraction particle size distribution measuring device “HELOS” (manufactured by SYMPATEC) equipped with a wet disperser.

The mixing amount of the toner with respect to the carrier is preferably in a range of 2% by mass or more and 10% by mass or less, with the total mass of the toner and the carrier being 100% by mass

### EXAMPLES

The effects of the invention will be described using the following examples and comparative examples. However, the technical scope of the invention is not limited only to the following examples.

### Preparation of Colorant Particle Dispersion

### Preparation of Yellow Colorant Particle Dispersion (Ye)

90 parts by mass of sodium dodecyl sulfate
200 parts by mass of C.I. pigment yellow 74
1,600 parts by mass of ion exchanged water
The solution obtained by mixing the above components was sufficiently dispersed using Ultra Turrax T50 (manufactured by IKA), and then treated using an ultrasonic disperser for 20 minutes to prepare a yellow colorant particle dispersion [Ye]. In the obtained yellow colorant particle dispersion [Ye], the volume-based median diameter of the yellow colorant particles was 240 nm.

### Preparation of Magenta Colorant Particle Dispersion (Ma)

90 parts by mass of sodium dodecyl sulfate
200 parts by mass of C.I. pigment red 269
1,600 parts by mass of ion exchanged water
The solution obtained by mixing the above components was sufficiently dispersed using Ultra Turrax T50 (manufactured by IKA), and then treated using an ultrasonic disperser for 20 minutes to prepare a magenta colorant particle dispersion [Ma]. In the obtained magenta colorant particle dispersion [Ma], the volume-based median diameter of the magenta colorant particles was 200 nm.

### Preparation of Cyan Colorant Particle Dispersion (Cy)

90 parts by mass of sodium dodecyl sulfate
200 parts by mass of C.I. pigment blue 15:3
1,600 parts by mass of ion exchanged water
The solution obtained by mixing the above components was sufficiently dispersed using Ultra Turrax T50 (manufactured by IKA), and then treated using an ultrasonic disperser for 20 minutes to prepare a cyan colorant particle dispersion [Cy]. In the obtained cyan colorant particle dispersion [Cy], the volume-based median diameter of the cyan colorant particles was 180 nm.

### Preparation of Black Colorant Particle Dispersion (Bk)

90 parts by mass of sodium dodecyl sulfate
200 parts by mass of carbon black “REGAL (registered trademark) 330R” (manufactured by Cabot Corporation)
1,600 parts by mass of ion exchanged water
The solution obtained by mixing the above components was sufficiently dispersed using Ultra Turrax T50 (manufactured by IKA), and then treated using an ultrasonic disperser for 20 minutes to prepare a black colorant particle dispersion [Bk]. In the obtained black colorant particle dispersion [Bk], the volume-based median diameter of the black colorant particles was 110 nm

### Preparation of Resin Particle Dispersion

### Preparation of Styrene/Acrylic Resin Particle Dispersion [Dispersion C1]

5.0 parts by mass of sodium lauryl sulfate and 2,500 parts by mass of ion exchanged water were put into a 5 L reaction vessel equipped with a stirrer, a temperature sensor, a cooling tube and a nitrogen introduction device, and an internal temperature was raised to 80° C. while performing stirring at a stirring speed of 230 rpm under a nitrogen stream. Subsequently, an aqueous solution in which 15.0 parts by mass of potassium persulfate (KPS) was dissolved in 300 parts by mass of ion exchanged water was added, and the liquid temperature was again set to 80° C. Thereafter, a monomer mixture including 840.0 parts by mass of styrene (St), 288.0 parts by mass of n-butyl acrylate (BA), 72.0 parts by mass of methacrylic acid (MAA) and 15 parts by mass of n-octyl mercaptan was dropped over two hours. After completion of dropping, polymerization was performed by heating and stirring at 80° C. for two hours to prepare a dispersion [C1] of styrene/acrylic resin [c1] particles having a volume-based median diameter of 120 nm. The glass transition temperature (Tg) of the styrene/acrylic resin [c1] was 52.0° C., and the weight average molecular weight (Mw) was 28,000.

### Preparation of Ultraviolet Absorbent Dispersion

### Preparation of Ultraviolet Absorbent Particle Dispersion 1

80 parts by mass of dichloromethane and 20 parts by mass of 2,2′-dihydroxy-4-4′-dimethoxybenzophenone (Uvinul (registered trademark) 3049, manufactured by BASF) as an ultraviolet absorbent were mixed and stirred while being heated at 50° C. to obtain a liquid containing the ultraviolet absorbent. A mixed solution of 99.5 parts by mass of distilled water heated to 50° C. and 0.5 parts by mass of a 20% by mass aqueous solution of sodium dodecylbenzenesulfonate was added to 100 parts by mass of this liquid. Thereafter, the mixture was stirred and emulsified using a homogenizer (manufactured by Heidorf) equipped with a shaft generator 18 F at 16,000 rpm for 20 minutes to obtain an ultraviolet absorbent emulsified liquid 1. The obtained ultraviolet absorbent emulsified liquid 1 was put into a separable flask, and heated and stirred at 40° C. for 90 minutes while sending nitrogen into the gas phase to remove an organic solvent. Thereafter, by adding ion exchanged water to the dispersion, the solid content was adjusted to be 20% by mass, thereby obtaining an ultraviolet absorbent particle dispersion 1. When the particle size of the ultraviolet absorbent particles in the ultraviolet absorbent particle dispersion 1 was measured using an electrophoretic light scattering photometer “ELS-800” (manufactured by Otsuka Electronics Co., Ltd.), the volume-based median diameter was 155 nm.

### Preparation of Infrared Absorbent Dispersion

### Preparation of Infrared Absorbent Particle Dispersion 1

Anionic surfactant: 90 g of sodium dodecylbenzenesulfonate was stirred and dissolved in 1,600 mL of ion exchanged water. While stirring this solution, 420 g of dithiol-based nickel complex “SIR-130” (manufactured by Mitsui Chemicals, Inc.) was gradually added as an infrared absorbent. Subsequently, after performing a dispersion treatment using a stirrer “CLEARMIX (registered trademark)” (manufactured by M Technique Co., Ltd.), the solid content was adjusted to be 20% by mass, and an infrared absorbent particle dispersion 1 in which the infrared absorbent particles were dispersed was prepared. When the particle size of the infrared absorbent particles in the infrared absorbent particle dispersion 1 was measured using an electrophoretic light scattering photometer “ELS-800” (manufactured by Otsuka Electronics Co., Ltd.), the volume-based median diameter was 80 nm.

### Production of Cyan Toner Cy1 and Cyan Developer Cy1

### Toner Base Particle Preparation Process

After putting 1483.3 parts by mass (445.0 parts by mass in terms of solid content) of styrene/acrylic resin particle dispersion liquid [C1], 236.3 parts by mass (25.0 parts by mass in terms of solid content) of the cyan colorant particle dispersion [Cy], and 1,500 parts by mass of ion exchanged water into a reaction vessel equipped with a stirrer, a temperature sensor, and a cooling pipe, the pH was adjusted to 10 by adding a 5 mol/l sodium hydroxide aqueous solution. Subsequently, an aqueous solution in which 45.0 parts by mass of magnesium chloride was dissolved in 45.0 parts by mass of ion exchanged water was added over 10 minutes at 30° C. with stirring. Heating was started, the temperature of this system was raised to 80° C. over 60 minutes, the particle size of the gathered particles was measured using “Coulter Multisizer 3” (manufactured by Beckman Coulter, Inc.), and the stirring speed was controlled so that the volume-based median diameter becomes 6.0 μm. Thereafter, an aqueous solution in which 45.0 parts by mass of sodium chloride was dissolved in 180.0 parts by mass of ion exchanged water was added to stop the particle growth. Further, the particles were fused by heating and stirring at a temperature of 80° C.

Using a measuring device for average circularity of toner particles (FPIA-2100; Sysmex), when the average circularity (number of HPF detected: 4,000) reached 0.957, cooling to 30° C. was performed at a cooling rate of 5° C./min.

Then, after repeating an operation of performing solid-liquid separation, re-dispersing dehydrated toner cake in ion exchanged water, and performing solid-liquid separation three times to perform washing, the toner base particles [Cy1] were obtained by drying at 40° C. for 24 hours.

### External Additive Addition Process

0.6 parts by mass of hydrophobic silica (number average primary particle size=12 nm, degree of hydrophobicity=68) and 1.0 part by mass of hydrophobic titanium oxide (number average primary particle size=20 nm, degree of hydrophobicity=63) were added to 100 parts by mass of the obtained toner base particles (Cy1), and mixed at 32° C. for 20 minutes under the condition of a rotating blade peripheral speed of 35 m/sec using a “Henschel mixer (registered trademark)” (manufactured by Nippon Coke Industry Co., Ltd.). Thereafter, coarse particles were removed using a sieve having an opening of 45 μm to obtain cyan toner [Cy1] including cyan toner particles [Cy1].

### Production Process of Developer

A ferrite carrier having a volume-based median diameter of 32 μm coated with a copolymer resin of cyclohexyl methacrylate and methyl methacrylate (monomer mass ratio=1:1) was mixed with the cyan toner [Cy1] to have a toner concentration of 6% by mass, thereby obtaining a cyan developer [Cy1].

### Production of Cyan Toner Cy2 and Cyan Developer Cy2

Except for a change in which 1,450.0 parts by mass (435.0 parts by mass in terms of solid content) of a styrene/acrylic resin particle dispersion [dispersion C1] and 50.0 parts by mass (10.0 parts by mass in terms of solid content) of an ultraviolet absorbent particle dispersion 1 are put instead of 1,483.3 parts by mass (445.0 parts by mass in terms of solid content) of the styrene/acrylic resin particle dispersion liquid [dispersion C1] in [Production of cyan toner Cy1 and cyan developer Cy1], cyan toner [Cy2] and a cyan developer [Cy2] were produced in the same manner as described above.

### Production of Yellow Toner Ye1, Magenta Toner Ma1, Black Toner Bk1, and Yellow Developer Ye1, Magenta Developer Ma1, and Black Developer Bk1

Except that the cyan colorant particle dispersion [Cy] was changed to a yellow colorant particle dispersion [Ye], a magenta colorant particle dispersion [Ma], and a black colorant dispersion [Bk], respectively in [Production of cyan toner Cy1 and cyan developer Cy1], yellow toner [Ye1] and a developer [Ye1], magenta toner [Ma1] and a magenta developer [Ma1], and black toner [Bk1] and a black developer [Bk1] were produced in the same manner as described above.

### Production of Cyan Toner Cy3 and Cyan Developer Cy3

The cyan toner [Cy1] and the black toner [Bk1] were mixed at a mass ratio of 10:1 to obtain cyan toner [Cy3]. A cyan developer [Cy3] was produced using the cyan toner [Cy3] in the same manner as the method for producing the cyan developer [Cy1].

### Production of Transparent Toner T1 and Transparent Developer T1

Except for a change in which 1,533.3 parts by mass (460.0 parts by mass in terms of solid content) of the styrene/acrylic resin particle dispersion [dispersion C1] and 50.0 parts by mass (10.0 parts by mass in terms of solid content) of an infrared absorbent particle dispersion 1 are put instead of 1,483.3 parts by mass (445.0 parts by mass in terms of solid content) of the styrene/acrylic resin particle dispersion liquid [dispersion C1] and 236.3 parts by mass (25.0 parts by mass in terms of solid content) of the colorant particle dispersion liquid [Cy] in [Production of cyan toner Cy1 and cyan developer Cy1], transparent toner [T1] and a transparent developer [T1] were produced in the same manner as described above.

### Example 1 to Example 8 and Comparative Example 1 and Comparative Example 2

In each example, an apparatus where a fixing device of bizhub PRESS (registered trademark) C1070 (manufactured by Konica Minolta, Inc.) is modified to have a configuration including the light irradiation unit 55 of FIG. 2 was used as the 3D image forming apparatus having the configuration illustrated in FIG. 2. Using the developer obtained as described above, according to a method shown in [Evaluation method] below under a normal temperature and normal humidity environment (temperature 20° C. and relative humidity 50% RH), a 3D image was formed and evaluated.

In the 3D image forming apparatus in which the fixing device is modified to a configuration including the light irradiation unit 55 of FIG. 2, the toner image was irradiated with light from an LED used as a light source corresponding to the light irradiation unit. Note that the maximum emission wavelength, the wavelength range, and the irradiation light amount of the irradiation light are shown in Table 1.

In Comparative Example 1, an attempt was made to form a 3D image in the same manner as in Example 1 except that no light irradiation was performed, and no 3D image was obtained as shown in Table 1.

In Comparative Example 2, a 3D image was formed in the same manner as in Example 1 except that the maximum emission wavelength of the irradiation light was set to a long wavelength. The obtained 3D image was determined according to the following evaluation criteria. Table 1 shows the obtained results.

### Evaluation Method

### Fixing Property Test

An A4-sized thermally expandable sheet having a stacked structure illustrated in FIG. 1 was prepared as a recording medium. An electrostatic latent image having a size of 10 mm×10 mm was developed on the thermally expandable sheet under the condition that the toner adhesion amount is 4 g/m² (development process). Thereafter, the toner image was transferred to the thermally expandable sheet (transfer process), and the medium surface on which the toner image is formed was irradiated with light under the conditions shown in Table 1 (light irradiation process), thereby forming a 3D image. Note that the total adhesion amount of the toner was adjusted to 4 g/m², and a mass ratio of each color toner is shown in Table 1.

The fixing strength of the 3D image was evaluated by a tape peeling test. After attaching a tape (Scotch (registered trademark) Mending Tape manufactured by 3M) to the 3D image, the tape was peeled off. Changes in the 3D image before and after the tape was peeled were evaluated on the following three levels. Cases where the evaluation corresponds to A and B were determined to be acceptable.

### Evaluation Criteria for Fixing Property

A: A density change of the 3D image may not be identified.
B: A slight change in the density of the 3D image is felt. However, there is no practical problem.
C: A density change of the 3D image is strongly recognized, or the 3D image is peeled off and the paper is exposed.

### Color Reproducibility Test

An electrostatic latent image having a size of 10 mm×10 mm was developed on the same A4-sized thermally expandable sheet as that used in the fixing property test under the condition that the toner adhesion amount is 4 g/m² (development process), the toner image was transferred to the thermally expandable sheet (transfer process), and the medium surface on which the toner image is formed was irradiated with light under the conditions described in Table 1 (light irradiation process), thereby forming a 3D image. The total adhesion amount of the toner was adjusted to 4 g/m², and a mass ratio of each color toner is shown in Table 1.

In addition, using bizhub PRESS (registered trademark) C1070 (manufactured by Konica Minolta Co., Ltd.) as a comparative sample, an image fixed at a 100 mm×100 mm size was output on plain paper (basis weight: 64 g/m²) under the condition that the toner adhesion amount is 4 g/m².

The 3D image sample and the comparative sample were compared and evaluated on the following three levels. Cases where the evaluation corresponds to A and B were determined to be acceptable.

### Evaluation Criteria for Color Reproducibility

A: Even when the 3D image sample is compared with the comparative sample, it is not possible to distinguish a difference in color (hue, lightness, and saturation) between the two samples.
B: When the 3D image sample is compared with the comparative sample, a slight difference in color between the two samples is felt. However, there is no problem in practical use (in the 3D image sample, the color is recognized as a slightly muddy image).
C: When the 3D image sample is compared with the comparative sample, a large difference in color between the two samples is recognized (in the 3D image sample, the color is recognized as a muddy image).

### Edge Test

An electrostatic latent image having a size of 10 mm×10 mm was developed on the same A4-sized thermally expandable sheet as that used in the fixing property test under the condition that the toner adhesion amount is 4 g/m² (development process), the toner image was transferred to the thermally expandable sheet (transfer process), and the medium surface on which the toner image is formed was irradiated with light under the conditions described in Table 1 (light irradiation process), thereby forming a 3D image. The total adhesion amount of the toner was adjusted to 4 g/m², and a mass ratio of each color toner is shown in Table 1. The sharp 3D effect at an edge portion of the 3D image was evaluated on the following three levels. Cases where the evaluation corresponds to A and B were determined to be acceptable.

### Evaluation Criteria for Edge

A: The bulge of the edge portion is sharp and has excellent 3D effect.
B: Even though the bulge of the edge portion is slightly widened, the sharp 3D effect is expressed and there is no practical problem.
C: The bulge of the edge portion is gentle, and the sharp 3D effect may not be felt.

### Example 9

In Example 9, an apparatus where a fixing device of bizhub PRESS (registered trademark) C1070 (manufactured by Konica Minolta, Inc.) is modified to have a configuration including the light irradiation unit 55 of FIG. 2 was used as the 3D image forming apparatus. Using the developer obtained as described above, a 3D image was formed according to the 3D image forming method under a normal temperature and normal humidity environment (temperature 20° C. and relative humidity 50% RH).

The 3D image forming apparatus used in Example 9 is an apparatus configured to irradiate the toner image with light from the LED used as a light source, and can control the amount of light irradiation for each position according to the 3D image information.

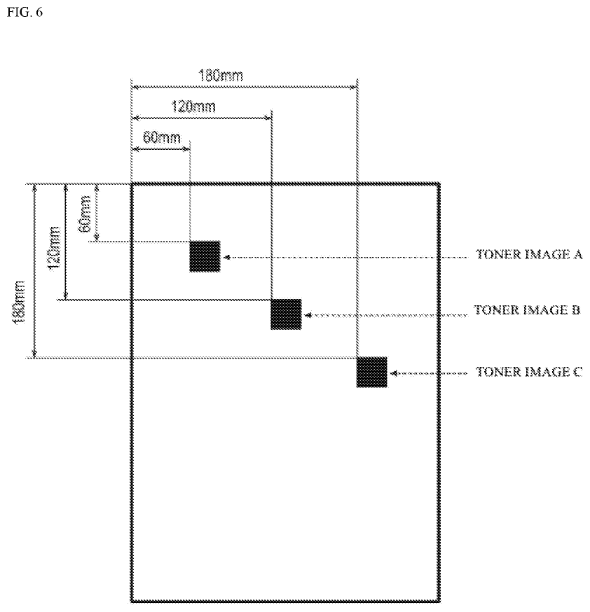

The electrostatic latent image was developed so that a toner image A, a toner image B, and a toner image C, each of which has a size of 10 mm×10 mm, can be formed at positions (illustrated in FIG. 6) of the same A4-sized thermally expandable sheet (capsule paper) as that used in the fixing property test under the condition that the toner adhesion amount is 4 g/m² (development process). The toner image A, the toner image B, and the toner image C were transferred to the thermally expandable sheet (transfer process), and the amount of light irradiation in the light irradiation process was set in advance so that the toner image A had a first step bulging height, the toner image B had a second step bulging height, and the toner image C had a third step bulging height. Note that FIG. 6 is a diagram illustrating formation positions of the toner image A, the toner image B, and the toner image C on an A4-sized thermally expandable sheet of Example 9.

In the light irradiation process, the toner image A was irradiated with light having the light irradiation amount of 5 J/cm², the toner image B was irradiated with light having the light irradiation amount of 15 J/cm², and the toner image C was irradiated with light having the light irradiation amount of 25 J/cm². When a height from a non-image portion to a top of the bulging portion using a color 3D laser microscope VK-9700 (manufactured by Keyence Corporation), the bulging height of the toner image A was 300 μm, the bulging height of the toner image B was 600 μm, and the bulging height of the toner image C was 900 μm.

The 3D image obtained in Example 9 was evaluated for the fixing property, the color reproducibility, and the edge in accordance with the evaluation criteria of the fixing property test, the color reproducibility test, and the edge test described above. Table 1 shows the obtained results. As a comparative sample for the color reproducibility test, the comparative sample of Example 1 was used.

### Comparative Example 3

In Comparative Example 3, an apparatus where a fixing device of bizhub PRESS (registered trademark) C1070 (manufactured by Konica Minolta, Inc.) is modified to have a configuration including the light irradiation unit 55 of FIG. 2 was used as the 3D image forming apparatus. Using the developer Cy4 obtained as described above, a 3D image was formed and evaluated by performing the fixing property test, the color reproducibility test, and the edge test under a normal temperature and normal humidity environment (temperature 20° C. and relative humidity 50% RH).

The toner image was irradiated with light using a halogen lamp as a light source. Note that the maximum emission wavelength, the wavelength range, and the irradiation light amount of the irradiation light are shown in Table 1. Table 1 shows the obtained results. As a comparative sample for the color reproducibility test, the comparative sample of Example 1 was used.

### Comparative Example 4

In Comparative Example 4, an apparatus where a fixing device of bizhub PRESS (registered trademark) C1070 (manufactured by Konica Minolta, Inc.) is modified to have a configuration including the light irradiation unit 55 of FIG. 2 was used as the 3D image forming apparatus. Using the developer Cy1 obtained as described above, a 3D image was formed and evaluated by performing the fixing property test, the color reproducibility test, and the edge test under a normal temperature and normal humidity environment (temperature 20° C. and relative humidity 50% RH).

Note that the transparent developer T1 containing the transparent toner T1 was placed at a position of the black developer in the 3D image forming apparatus, and was set so that the transparent toner was on a lower layer and the cyan toner was on an upper layer on the image.

The toner image was irradiated with light using an LED as a light source. Note that the maximum emission wavelength, the wavelength range, and the irradiation light amount of the irradiation light are shown in Table 1.

That is, in Comparative Example 4, the fixing property test, the color reproducibility test, and the edge test of the evaluation method were performed in the same manner as in Example 1 except that the maximum emission wavelength of the irradiation light was set to a long wavelength to form and evaluate a 3D image. Table 1 shows the obtained results. As a comparative sample for the color reproducibility test, the comparative sample of Example 1 was used.

TABLE 1

| | Toner | | | | | | | | | | | |
|---|---|---|---|---|---|---|---|---|---|---|---|---|
| | | | | | | | | | Compound that absorbs light in | | | |
| | Toner No | | | | Mass ratio of each toner | | | | wavelength range of irradiation | | | |
| | Yellow | Magenta | Cyan | Others | Yellow | Magenta | Cyan | Others | Yellow | Magenta | Cyan | Others |
| Example 1 | — | — | Cy1 | — | — | — | 100 | — | — | — | Colorant | — |
| Example 2 | — | — | Cy1 | — | — | — | 100 | — | — | — | Colorant | — |
| Example 3 | — | — | Cy1 | — | — | — | 100 | — | — | — | Colorant | — |
| Example 4 | — | — | Cy1 | — | — | — | 100 | — | — | — | Colorant | — |
| Example 5 | — | — | Cy1 | — | — | — | 100 | — | — | — | Colorant | — |
| Example 6 | — | — | Cy2 | — | — | — | 100 | — | — | — | Colorant/ | — |
| | | | | | | | | | | | ultraviolet | |
| | | | | | | | | | | | absorbent | |
| Example 7 | Ye1 | Ma1 | Cy1 | — | 30 | 30 | 40 | — | Colorant | Colorant | Colorant | — |
| Example 8 | Ye1 | Ma1 | Cy1 | Bk1 | 25 | 25 | 25 | 25 | Colorant | Colorant | Colorant | Colorant |
| Example 9 | — | — | Cy1 | — | — | — | 100 | — | — | — | Colorant | — |
| Comparative | — | — | Cy1 | — | — | — | 100 | — | — | — | Colorant | — |
| Example 1 | | | | | | | | | | | | |
| Comparative | — | — | Cy1 | — | — | — | 100 | — | — | — | — | — |
| Example 2 | | | | | | | | | | | | |
| Comparative | — | — | Cy3 | — | — | — | 100 | — | — | — | Black | — |
| Example 3 | | | | | | | | | | | colorant | |
| Comparative | — | — | Cy1 | T1 | — | — | 80 | 20 | — | — | — | Infrared |
| Example 4 | | | | | | | | | | | | absorbent |

| | Process of irradiating light | | | | | | |
|---|---|---|---|---|---|---|---|
| | | | Wavelength | | | | |
| | | Maximum | range of | Irradiation | Fixing | Color | |
| | | emission | irradiation | light | property | reproducibility | Edge |
| | Light | wavelength | light | amount | test | test | test |
| | source | [nm] | [nm] | [J/cm²] | result | result | result |
| Example 1 | LED | 365 | 365 ± 20 | 5.0 | A | A | A |
| Example 2 | LED | 385 | 385 ± 10 | 5.2 | A | A | A |
| Example 3 | LED | 405 | 405 ± 10 | 5.6 | A | A | A |
| Example 4 | LED | 480 | 480 ± 20 | 6.6 | A | A | A |
| Example 5 | LED | 780 | 780 ± 20 | 7.0 | B | A | B |
| Example 6 | LED | 365 | 365 ± 20 | 4.0 | A | B | A |
| Example 7 | LED | 365 | 365 ± 20 | 5.0 | A | A | A |
| Example 8 | LED | 365 | 365 ± 20 | 5.0 | A | A | A |
| Example 9 | LED | 365 | 365 ± 20 | 5.0 (Toner | A | A | A |
| | | | | image A) | | | |
| | | | | 15.0 (Toner | A | A | A |
| | | | | image B) | | | |
| | | | | 25.0 (Toner | A | A | A |
| | | | | image C) | | | |
| Comparative | No light irradiation | | | | 3D image not obtained | | |
| Example 1 | | | | | | | |
| Comparative | LED | 1050 | 1050 ± 20 | 5.0 | C | B | C |
| Example 2 | | | | | | | |
| Comparative | Halogen | 1000 | 400 to 3,000 | 5.0 | B | C | B |
| Example 3 | lamp | | | | | | |
| Comparative | LED | 1050 | 1050 ± 20 | 5.0 | B | C | B |
| Example 4 | | | | | | | |

In Comparative Examples 2 and 4, the cyan toner Cy1 is used. An absorbance of the cyan colorant of the cyan toner Cy1 is less than 0.01 at a maximum emission wavelength of 1,050 nm, and the cyan colorant does not correspond to “compound that absorbs light in wavelength range of irradiation” of Table 1. For this reason, “-” is used to indicate that “compound that absorbs light in wavelength range of irradiation” of Table 1 corresponds to “not included” in “cyan”.

Meanwhile, the absorbance of the cyan colorant of the cyan toner Cy1 is 0.01 or more at each of the maximum emission wavelengths 365 nm (Examples 1 and 6 to 9), 385 nm (Example 2), 405 nm (Example 3), 480 nm (Example 4), and 780 nm (Example 5), and corresponds to “compound that absorbs light in wavelength range of irradiation” of Table 1. For this reason, “colorant” is written in each field of “cyan” in “compound that absorbs light in wavelength range of irradiation” of Table 1.

Note that in Example 6, the cyan toner Cy1 contains an ultraviolet absorbent, an absorbance of this ultraviolet absorbent is 0.01 or more at a maximum emission wavelength of 365 nm, and the ultraviolet absorbent corresponds to “compound that absorbs light in wavelength range of irradiation” of Table 1. For this reason, “ultraviolet absorbent” together with “colorant” are written a field of “cyan” in “compound that absorbs light in wavelength range of irradiation” of Table 1.

Note that in the definition of the compound A, “the absorbance at the maximum emission wavelength is 0.01 or more”. In this way, it is determined whether an absorbent corresponds to the compound A based on the absorbance at the maximum emission wavelength in the wavelength range of the irradiated light.

The cyan toner Cy4 of Comparative Example 3 is a mixture of the cyan toner Cy1 and the black toner Bk1, and includes the cyan colorant of the cyan toner Cy1 and the black colorant of the black toner Bk1. In this instance, the cyan colorant has an absorbance of less than 0.01 at a maximum emission wavelength of 1,000 nm, and the black colorant has an absorbance of 0.01 or more at a maximum emission wavelength of 1,000 nm. For this reason, “black colorant” is written in a field of “cyan” in “compound that absorbs light in wavelength range of irradiation” of Table 1.

The clear toner T1 of Comparative Example 4 does not include a colorant, and includes an infrared absorbent. An absorbance of the infrared absorbent at a maximum emission wavelength of 1,050 nm is 0.01 or more. For this reason, “infrared absorbent” is written in a field of “others” in “compound that absorbs light in wavelength range of irradiation” of Table 1. Note that although not shown in Table 1, an absorbance of the infrared absorbent used in Comparative Example 4 is less than 0.01 in a wavelength range of a maximum emission wavelength of 780 nm or less. For this reason, even when the infrared absorbent is applied to color toners (yellow toner, magenta toner, cyan toner, etc.), it can be considered that the infrared absorbent may not function as the compound A in a wavelength range of a maximum emission wavelength of 280 nm or more and 780 nm or less.

From the results of Table 1, it could be found that Examples 1 to 9 using the 3D image forming apparatus and the 3D image forming method of the present embodiment have the excellent fixing property and color reproducibility and can form a 3D image having a sharp edge.

On the other hand, Comparative Examples 1 to 4 did not use the 3D image forming apparatus and the 3D image forming method of the present embodiment, and thus it was found that at least one of the fixing property, the color reproducibility and the edge test did not satisfy the passing criteria.

Even though the embodiment of the present invention has been described in detail, the embodiment is explanatory and illustrative and not restrictive, and it is clear that the scope of the invention should be interpreted by the appended claims Further, the invention is not limited to the above-described embodiment, and various modifications can be made.

Note that this application is based on Japanese Patent Application No. 2019-085645 filed on Apr. 26, 2019, the disclosure of which is incorporated by reference in its entirety.

What is claimed is:

1. A three-dimensional (3D) image forming method for forming a color 3D image on a recording medium having a thermal expansion property, the method comprising at least:
developing an electrostatic latent image using toner to form a toner image;
transferring the toner image to the recording medium; and
irradiating a medium surface on which the toner image is formed with light having a maximum emission wavelength in a wavelength range of 280 nm or more and 780 nm or less and being allowed to be absorbed by a compound contained in the toner.

2. The 3D image forming method according to claim 1, wherein the irradiating includes irradiating light having a maximum emission wavelength in a wavelength range of 280 nm or more and 680 nm or less.

3. The 3D image forming method according to claim 1, wherein the irradiating includes irradiating light having a maximum emission wavelength in a wavelength range of 280 nm or more and 480 nm or less.

4. The 3D image forming method according to claim 1, wherein the toner corresponds to at least one of yellow toner, magenta toner, and cyan toner.

5. The 3D image forming method according to claim 1, wherein the irradiating includes irradiating light using a light emitting diode or a laser light source.

6. The 3D image forming method according to claim 1, wherein the irradiating includes setting a light irradiation position on the basis of position information of the toner image based on print image data.

7. The 3D image forming method according to claim 1, wherein the irradiating includes setting a light irradiation amount on the basis of 3D image information of the toner image designated by a user.

8. The 3D image forming method according to claim 1, wherein the toner contains a colorant as the compound.

9. The 3D image forming method according to claim 1, wherein the toner contains an ultraviolet absorbent as the compound.

10. A 3D image forming apparatus for forming a color 3D image on a recording medium having a thermal expansion property, the apparatus comprising at least:
a developing unit that develops an electrostatic latent image using toner to form a toner image;
a transfer unit that transfers the toner image to the recording medium; and
a light irradiation unit that irradiates a medium surface on which the toner image is formed with light having a maximum emission wavelength in a wavelength range of 280 nm or more and 780 nm or less and being allowed to be absorbed by a compound contained in the toner.

11. A 3D image forming apparatus used for the 3D image forming method according to claim 1.
